(19) United States
(12) Patent Application Publication
(10) Pub. No.: US 2012/0030584 A1
(43) Pub. Date: Feb. 2, 2012

(54) METHOD AND APPARATUS FOR DYNAMICALLY SWITCHING BETWEEN SCALABLE GRAPHICAL USER INTERFACES FOR MOBILE DEVICES

(76) Inventor: Brian Bian, Portland, OR (US)

(21) Appl. No.: 12/847,596

(22) Filed: Jul. 30, 2010

(51) Int. Cl. G06F 3/01

(52) U.S. Cl. 715/746

(57) ABSTRACT

A method, apparatus and system enable mobile platforms to dynamically switch between scalable graphical user interfaces. Mobile device users may couple their mobile devices to computing platforms with larger display devices. Upon detection of the larger display device, the mobile platform may select an appropriate user interface scheme to display the content on the larger display device.

### BACKGROUND

Mobile handheld devices continue to proliferate the consumer electronic market at an increasingly rapid rate. Typically, because these devices include user interfaces that are designed to work around the small screen sizes of the devices, the users may be provided with a different interface than they are used to if they were using their larger computing platforms (e.g., a desktop or laptop). For example, a user with a Nokia mobile device running an Intel/Nokia Meego operating system may be presented with a MeeGo user interface tailored for its small screen. Similarly, applications running on the Nokia mobile platform may be tailored for the small screen size. These operating systems and mobile applications typically take into account the limited screen size as well as limited input capabilities on a mobile device, in addition to significantly less memory.

### BRIEF DESCRIPTION OF THE DRAWINGS

The present invention is illustrated by way of example and not limitation in the figures of the accompanying drawings in which like references indicate similar elements, and in which:

FIG. 1 illustrates an existing mobile computing display scheme;

FIG. 2 illustrates a system according to an embodiment of the present invention;

FIG. 3 is a flow chart illustrating an embodiment of the present invention; and

FIG. 4 is a flow chart illustrating an embodiment of the present invention.

### DETAILED DESCRIPTION

Embodiments of the present invention provide a method, apparatus and system for allowing mobile platforms to dynamically switch between scalable graphical user interfaces. As used in this specification, the phrases “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

Additionally, reference in the specification to the term “device”, “machine” or “apparatus” may include any one of a number of processor based computing devices, including but not limited to desktop computing devices, portable computing devices (laptops as well as handhelds), set-top boxes, and game consoles. Handheld devices may include, but are not limited to, smart phones, personal digital assistants (PDAs), mobile internet devices (MIDs), laptops, digital cameras, media players, ultra mobile personal computers (UMPCs) and/or any computing device that is capable of roaming on, and connecting to, a network.

As previously discussed, mobile computing devices are becoming increasingly prolific. As the devices evolve and become more sophisticated and capable of handing more and more of the users' day to day computing needs, users are likely to move towards using their mobile devices as their main computing devices. These devices continue to suffer, however, from extremely limited screen. As a result, even though users may more towards utilizing their mobile devices as their main computing devices, they nonetheless are likely to desire the usage of a large display device and/or one or more standard input devices such as a keyboard, a mouse and/or a remote control.

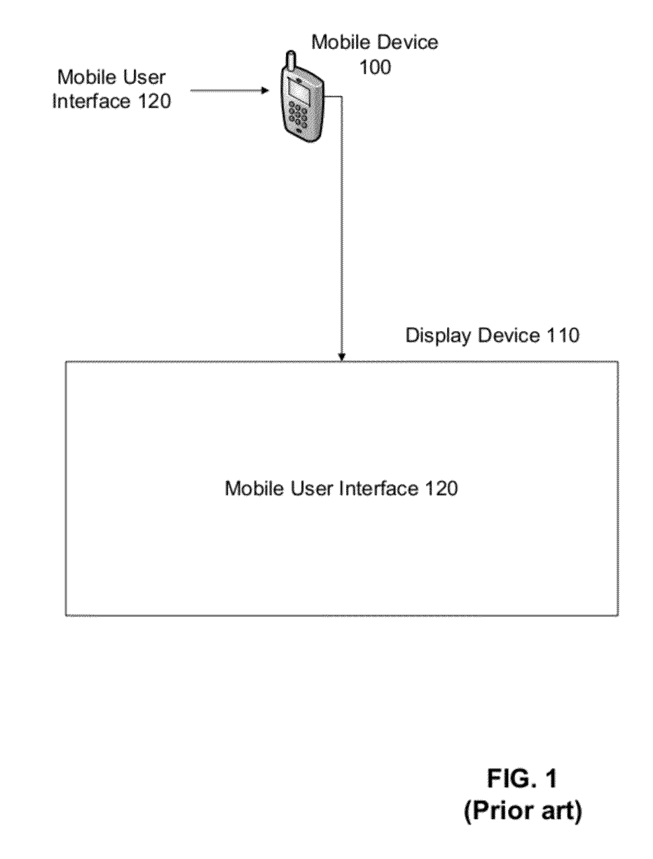

One example of such a scenario in which users take advantage of a larger display is evident in the Microsoft Zune HD platform. Users today may couple their Zune HD mobile devices to a television via a High Definition Media Interface (“HDMI”) interface. Once coupled, the users may see the same user interface previously displayed on the Zune HD device. In other words, the user interface that the user was viewing on the Zune HD device is simply projected onto the television screen without any alternations. The user may then manipulate the contents of the Zune HD device using the Zune HD device remote control unit that is sold together with the Zune HD device. FIG. 1 illustrates an example of such a scenario. As illustrated, a user with a mobile device (Mobile Device 100) may be coupled to a television and/or a computing device having a larger display area (illustrated conceptually as “Display Device 105”). The user interface on Mobile Device 100 (Mobile User Interface 110) may then be displayed on Display Device 105, thus enabling the user to take advantage of a larger display device.

According to one embodiment of the present invention, a mobile device may be coupled to a large display device but instead of displaying the same interface as that shown on the mobile device screen, the mobile device may instead dynamically switch to a completely different user interface, depending on the user's needs. This mutable, dynamically switchable scheme according to an embodiment of the present invention enables users' to experience a platform using a user interface tailored to that particular platform. In other words, if the user is on a mobile platform, the user may be presented with a mobile platform user interface but if the user couples the mobile platform to a large screen monitor or a television screen, the user interface presented to the user may be tailored to that platform. Thus, for example, if the display detected by the mobile device is a large screen monitor, the mobile device may utilize information about the type of display device to dynamically select a user interface for a desktop monitor, such as those typically used in Microsoft Windows and/or MacOS environments.

The following scenario describes an embodiment of the present invention. A user may access an article from the Internet on his Nokia mobile device while sitting outside in his/her patio. Once indoors, however, the user may elect to “dock” or otherwise couple the Nokia mobile device to a larger display device. For the purposes of this example, the Nokia mobile device may be docked in a docking station, similar to docking stations available to notebook computing devices and/or netbook computing devices today, but embodiments of the invention are not so limited. The mobile device may be coupled to the display device according to any known connection methodology, including being directly connected via a HDMI connection and/or wirelessly connected via technology such as Intel's Wireless Display (WiDi).

In the example utilizing a docking station, the docking station may be coupled to an external display device, a mouse and/or a keyboard or any other such input device. Once docked, the Nokia mobile device may automatically detect the presence of the larger display device. Once detected, in one embodiment, the mobile device may not only dynamically switch and display the contents of the article from the mobile device to the larger display device, it may also dynamically switch user interfaces from the MeeGo operating system user interface to a user interface more typically seen by notebook/netbook users. In one embodiment, this user interface may resemble a Microsoft Windows user interface while in an alternate embodiment, the user may be presented with an interface resembling the Apple MacOS user interface.

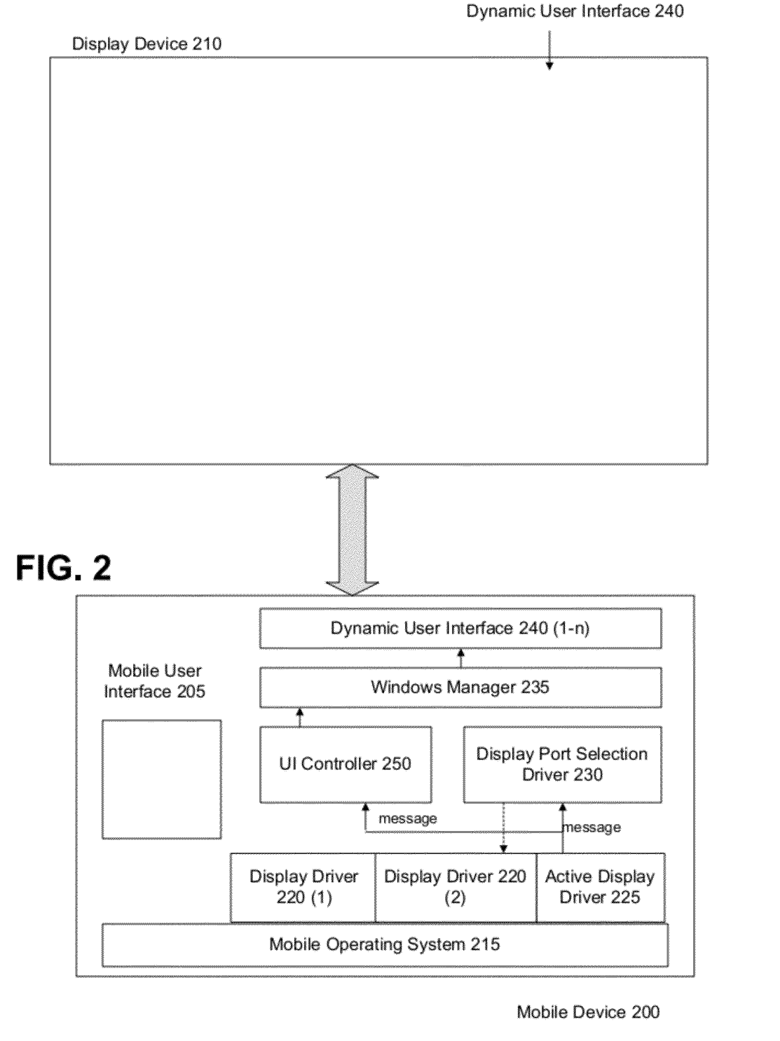

FIG. 2 illustrates conceptually an embodiment of the present invention as described above. As illustrated, similar to the scenario in FIG. 1, a mobile device (Mobile Device 200) may be coupled to a larger display device (Display Device 210). In an embodiment of the present invention, as illustrated, the user may see a mobile user interface (Mobile User Interface 205) if he/she is simply roaming with Mobile Device 200, but, when coupled to a larger monitor (Display Device 210), a dynamic scalable user interface selection controller (illustrated as “UI Controller 250”) may dynamically switch Mobile User Interface 205 to a new user interface that more closely resembles the native user interface on that new platform (Dynamic User Interface 210). Although UI Controller 250 is illustrated as residing in Mobile Device 200, embodiments of the invention are not so limited. Instead, UI Controller 250 may be implemented such that it is merely coupled to Mobile Device 200.

Mobile Device User Interface 205 may comprise any user interface typically available on mobile devices, including the Intel/Nokia MeeGo operating system interface, Google's Android operating system, Apple's iPhone operating system, and other existing or future developed mobile platform operating systems. Similarly, Dynamic User Interface 210 may resemble any currently known user interfaces (e.g., Microsoft Windows's user interface, Apple MacOS's user interface, Linux systems' user interface, etc.) as well as future developed user interfaces.

In one embodiment of the invention, the native user interface may simply present the user with a customized view of an application running on the mobile device, thus requiring no modification to the applications. In other embodiments, mobile applications may be modified to include different application that launches when the user interface is changed. For example, if a mobile email application is running on the mobile device, when the user interface switches to a desktop interface upon detection of a desktop display, the mobile device may launch the desktop email application (e.g., with a Microsoft Outlook type user interface) which enables more functionality for the user with a familiar user interface for the desktop environment. In yet other applications, applications may appear to the user as a single application but may in fact include mobile versions of the application as well as desktop versions, depending on the user interface scheme. Upon switching to a different user interface, in various embodiments, the applications may be relaunched by the user or by the UI controller. Regardless of how the applications are bundled, the user nonetheless continues to enjoy the user interface that is appropriate for the particular platform he/she is on.

The following description expands further on an embodiment of the present invention. As illustrated the operating system (Mobile Operating System 215) running on the mobile devices may be modified to enable the dynamic switching described herein but embodiments of the invention are not so limited. In alternate embodiments, Mobile Operating System 215 may be coupled to an external component that enables the dynamic switching described herein. For the purposes of simplicity, the remaining discussion assumes a modified operating system,

Mobile Operating System 215 is dependent on the type of mobile device. Thus, for example, on an Intel/Nokia mobile platform, Mobile Operating System 215 may comprise the MeeGo operating system. Mobile Operating System 215 may install multiple display drivers (illustrated collectively as “Display Drivers 220 (1) (2)”), to support multiple types of displays (e.g., local mobile displays, external High Definition Multimedia Interface (HDMI) displays, Intel Wireless Display (WiDi) displays, etc.). Typically, on a platform, a single top level display driver (hereafter referred to as a “Display Port Selection Driver 225”) may select one (or more) of the Display Drivers on the platform to be the currently active display driver (“Active Display Driver 220”), i.e. the display driver that is to be utilized by the platform based on the existing set of conditions. The concept of display drivers is well known to those of ordinary skill in the art. Each operating system vendor may refer to the Display Drivers 220 differently. In Microsoft Windows, for example these drivers are typically known as “display miniport drivers”. Use of more than one display driver is well known to those of ordinary skill in the art. Examples of such scenarios include a device that is coupled to two separate display devices (e.g. a notebook coupled to the local LCD screen as well as an external display) to either show mirrored images on each display or to enable extended display (i.e., enabling the screen real estate of both display devices to be used as a single larger display). For the purposes of simplicity, the descriptions herein assume that only one display is active but embodiments of the invention are not so limited and may be extended to include multiple displays.

In one embodiment, when Active Display Driver 225 (i.e. the currently activated Display Driver) on the mobile device detects the presence of a docking action, the availability of a large display or even by manual command from the user, Active Display Driver 225 may send an event or message to Display Port Selection Driver 230. According to one embodiment of the present invention, Display Port Selection Driver 230 may utilize this event to determine an appropriate new Active Display Driver 225 for the platform. Thus, if the mobile device is docked to a large screen display device, Display Port Selection Driver 230 may determine that the mobile device is coupled via HDMI to a television screen or display via Intel Wireless Display (WiDi) technology. Display Port Selection Driver 230 may thereafter select an appropriate driver for the large screen display and reroute the display from the mobile device to a different one of the Display Drivers 220. This newly selected Display Device Driver 220 (2) thus becomes the currently Active Display Driver 225 for the platform.

In one embodiment, UI Controller 250 illustrated in FIG. 2 may intercept (or otherwise receive) the event sent from Active Display Driver 225 to Display Port Selection Driver 230. Upon receipt of the event and information about the new display driver to which the display has been rerouted, UI Controller 250 may invoke a Window Manager on the mobile platform (Window Manager 235, i.e., the component that typically oversees all the display devices on the platform) on the mobile platform to switch the graphical user interface to be displayed on that particular platform. Thus, for example, if the UI Controller 250 is aware that the new display driver for the mobile platform is Display Driver (2), i.e., a large screen monitor rather than the mobile platform screen, UI Controller 250 may request from or instruct Window Manager 235 to switch the graphical user interface used by the operating system from one of the Dynamic User Interfaces 240 (1−n) to another appropriate for that platform (e.g., a user interface that resembles Microsoft Windows for a large screen display).

In an alternate embodiment, Mobile Device 200 may have multiple different Window Managers 235 installed, each for a specific graphical user interface. In this scenario, upon receipt of an event/message that a new display device is coupled to the mobile device, UI Controller 250 may invoke a new Window Manager 235 corresponding to the appropriate user interface for the new display device. Thus, in the example above, if UI Controller 250 is aware that the new display driver for the mobile platform is Display Driver (2), i.e., a large screen monitor rather than the mobile platform screen, UI Controller 250 shut down one Window Manager 235 (corresponding to the mobile device screen) and invoke a new Window Manager 235 (corresponding to the new platform) thus switching the graphical user interface used by the operating system to another appropriate for that platform (e.g., a user interface that resembles Microsoft Windows for a large screen display).

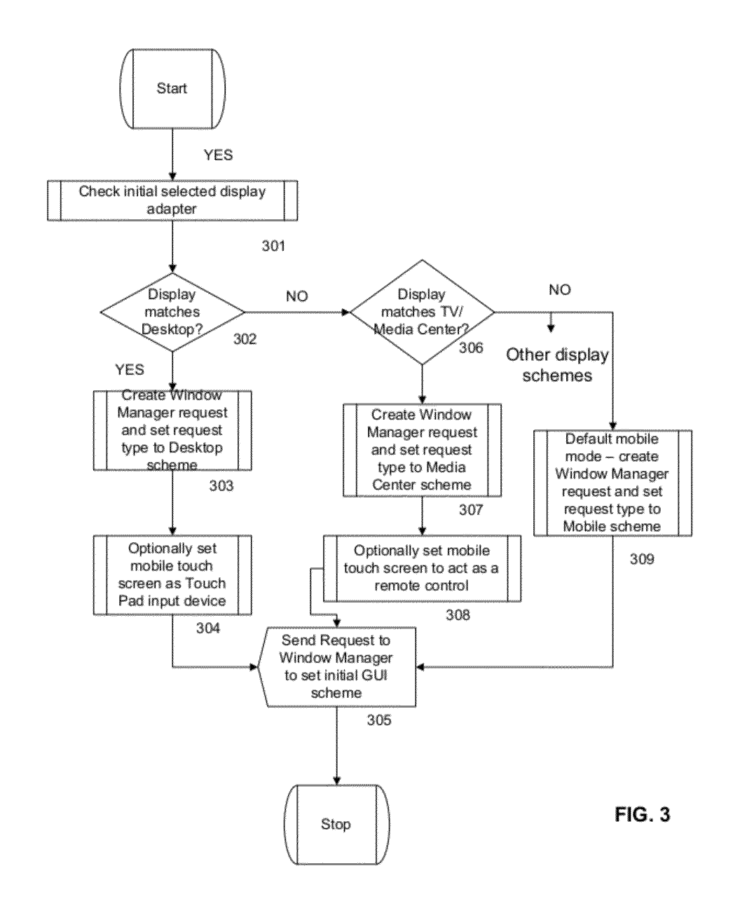

FIG. 3 is a flow chart illustrating one embodiment of the present invention. Although the following operations may be described as a sequential process, many of the operations may in fact be performed in parallel and/or concurrently. In addition, in one or more embodiments, the order of the operations may be re-arranged without departing from the spirit of embodiments of the invention. This flow chart assumes that the displays may be either a desktop display or a TV/media center display, but embodiments of the invention are not so limited and include any and all other types of display devices today or that may be developed in the future.

In 301, when a mobile device starts up, it may check to determine the a I/O devices (including display devices) accessible to the mobile device. In one embodiment, this check may occur automatically while in an alternate embodiment, a user may elect to check for such devices. In 302, the UI controller may examine newly discovered I/O devices to determine whether the devices match an desktop external display scheme. If it does, in 303, the UI Controller may create a request to the Window Manager for a new user interface scheme appropriate to the desktop display device. Optionally, in 304, the request may set the mobile device touch screen or other keyboard input as an input device to the external display device. The mobile device may then in 305 send the request for the new display scheme to the windows manager.

If, however, in 302, the I/O devices do not match a desktop external display scheme, in 306, the UI Controller may determine whether it matches a TV/media center display scheme. If it does, in 307, the UI Controller may create a request to the Display Manger for a new user interface scheme appropriate to the TV/media center display device. Optionally, in 308, the request may set the mobile device touch screen or other keyboard input as an input device to the external TV/media center display device. The mobile device may then in 305 sends the request for the new display scheme to the Window Manager. If the I/O devices do not match either the desktop or TV/media center scheme then in 309, the UI controller may optionally continue to check for other defined user interface schemes until it finally determines that the mode remains should a default mode in 309 (e.g., mobile display mode or other such mode as defined by the user).

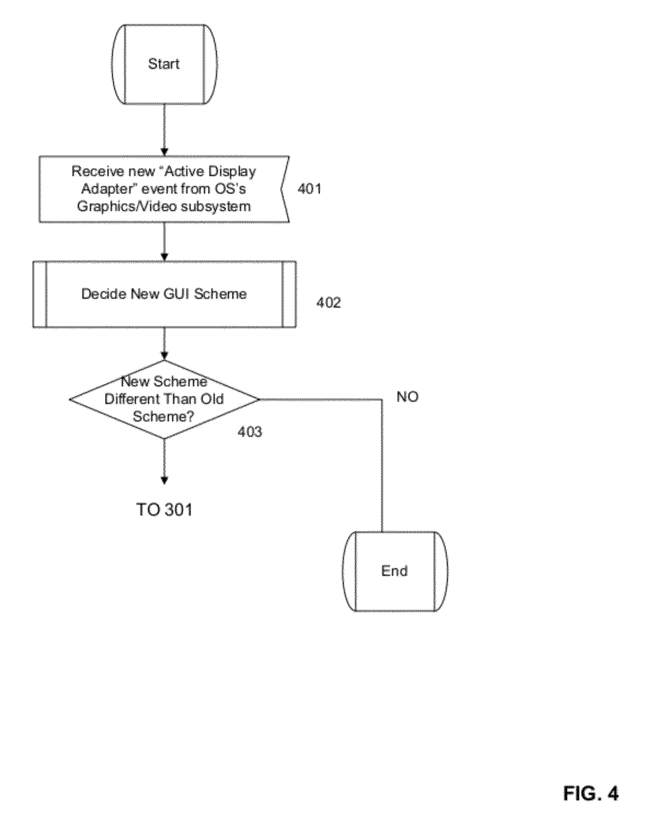

FIG. 4 is a flow chart illustrating in further detail the functionality of one embodiment of the present invention. Although the following operations may be described as a sequential process, many of the operations may in fact be performed in parallel and/or concurrently. In addition, in one or more embodiments, the order of the operations may be re-arranged without departing from the spirit of embodiments of the invention. In 401, after the initial startup described in FIG. 2, the UI Controller may receive a new “event” or message. In 402, the UI Controller may determine a new display scheme by determining in 403 whether the new scheme is different than the old scheme. If it is different, then the process may continue on to the process outlined in FIG. 3 above, i.e., from step 301 onward. If, however, the new scheme is the same as the old scheme, then the UI controller may require any changes be made.

The scheme according to embodiments of the present invention may be implemented on a variety of computing devices. According to an embodiment, a computing device may include various other well-known components such as one or more processors which can be specialized Reduced Instruction Set Computer (RISC) engines or general purpose processing engines. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. One or more of these elements may be integrated together with the processor on a single package or using multiple packages or dies. A host bus controller such as a Universal Serial Bus (“USB”) host controller may be coupled to the bus(es) and a plurality of devices may be coupled to the USB. For example, user input devices such as a keyboard and mouse may be included in the computing device for providing input data. In alternate embodiments, the host bus controller may be compatible with various other interconnect standards including Ethernet, Gigabit Ethernet, PCI, PCI Express, FireWire. Bluetooth, WiFi, infrared and other such existing and future standards.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

1. A method comprising:
on a mobile platform having a mobile display screen with a user interface scheme, identifying at least one new display device coupled to the mobile platform;
determining the type of the at least one new display device coupled to a mobile platform;
determining a new user interface scheme corresponding to the type of at least one new display device coupled to the mobile platform;
dynamically switching to the new user interface scheme corresponding to the type of the at least one display device coupled to the mobile platform; and
dynamically switching display output from the mobile platform to the new display device coupled to the mobile platform.

2. The method according to claim 1 further comprising:
retaining the mobile display screen's user interface scheme on the mobile display screen and displaying the new interface scheme on the at least one new display device.

3. The method according to claim 1 further comprising:
dynamically switching to an input scheme corresponding to the type of at least one display device coupled to the mobile platform.

4. The method according to claim 3 wherein switching the input device further comprises retaining an input scheme for the mobile display screen as an input to the at least one new display device.

5. The method according to claim 1 wherein the user interface scheme corresponding to the type of the at least one display device coupled to the mobile platform is a user interface scheme that is native to the type of display device.

6. The method according to claim 5 wherein the type of display device includes at least one of a large screen computing monitor, a television and a media center display.

7. The method according to claim 1 further comprising:
identifying a second new display device coupled to the mobile platform;
determining a type of the second new display device coupled to the mobile platform;
determining a second new user interface scheme corresponding to the type of the second new display device coupled to the mobile platform;
dynamically switching to the second new user interface scheme corresponding to the type of second new display device coupled to the mobile platform; and
dynamically switching to the second new display device while continuing to display to the new display device coupled to the mobile platform.

8. A mobile platform having a mobile display screen with a user interface scheme, comprising:
a display driver to identify at least one new display device coupled to the mobile platform;
a display port selection driver coupled to the display driver, the display port selection driver to determine the type of the at least one new display device coupled to a mobile platform;
a user interface (UI) controller to determine a new user interface scheme corresponding to the type of the at least one new display device coupled to the mobile platform, the UI controller to instruct a windows manager to dynamically switch to the new user interface scheme corresponding to the type of the at least one display device coupled to the mobile platform, the UI controller to further instruct the display port selection driver to dynamically switch display output from the mobile platform to the new display device coupled to the mobile platform.

9. The mobile platform according to claim 8 wherein the UI controller to further retain the mobile display screen's user interface scheme on the mobile display screen and displaying the new interface scheme on the at least one new display device.

10. The mobile platform according to claim 8 wherein the UI controller to further dynamically switch to an input scheme corresponding to the type of at least one display device coupled to the mobile platform.

11. The mobile platform claim 10 wherein switching the input device further comprises retaining an input scheme for the mobile display screen as an input to the at least one new display device.

12. The mobile platform according to claim 8 wherein the user interface scheme corresponding to the type of the at least one display device coupled to the mobile platform is a user interface scheme that is native to the type of display device.

13. The mobile platform according to claim 12 wherein the type of display device includes at least one of a large screen computing monitor, a television and a media center display.

14. The mobile platform according to claim 8 wherein:
the display driver to further identify a second new display device coupled to the mobile platform;
the display port driver to further determine a type of the second new display device coupled to the mobile platform;
a user interface (UI) controller to determine a second new user interface scheme corresponding to the type of the second new display device coupled to the mobile platform, the UI controller to instruct the windows manager to dynamically switch to the second new user interface scheme corresponding to the type of second new display device coupled to the mobile platform, the UI controller additionally to instruct the device port selection driver to dynamically switch to the second new display device while continuing to display to the new display device coupled to the mobile platform.

15. A machine-accessible device having stored thereon instructions that, when executed by a machine, cause the machine to:
identify at least one new display device coupled to a mobile platform having a mobile display screen with a user interface scheme;
determine the type of the at least one new display device coupled to a mobile platform;
determine a new user interface scheme corresponding to the type of at least one new display device coupled to the mobile platform;
dynamically switch to the new user interface scheme corresponding to the type of the at least one display device coupled to the mobile platform; and
dynamically switch to the new display device coupled to the mobile platform.

16. The machine-accessible device according to claim 15 wherein the instructions that, when executed by the machine, cause the machine to further:
retain the mobile display screen's user interface scheme on the mobile display screen and display the new interface scheme on the at least one new display device.

17. The machine-accessible device according to claim 15 wherein the instructions that, when executed by the machine, cause the machine to further dynamically switch to an input scheme corresponding to the type of at least one display device coupled to the mobile platform.

18. The machine-accessible device according to claim 17 wherein the instructions that, when executed by the machine, cause the machine to further switch the input device while continuing to retain an input scheme for the mobile display screen as an input to the at least one new display device.

19. The machine-accessible device according to claim 15 wherein the user interface scheme corresponding to the type of the at least one display device coupled to the mobile platform is a user interface scheme that is native to the type of display device.

20. The machine-accessible device according to claim 19 wherein the type of display device includes at least one of a large screen computing monitor, a television and a media center display.

21. The machine-accessible device according to claim 15 wherein the instructions that, when executed by the machine, cause the machine to further:
identify a second new display device coupled to the mobile platform;
determine a type of the second new display device coupled to the mobile platform;
determine a second new user interface scheme corresponding to the type of the second new display device coupled to the mobile platform;
dynamically switch to the second new user interface scheme corresponding to the type of second new display device coupled to the mobile platform; and
dynamically switch to the second new display device while continuing to display to the new display device coupled to the mobile platform.
